(19) United States
(12) Patent Application Publication
(10) Pub. No.: US 2017/0059790 A1
(43) Pub. Date: Mar. 2, 2017

(54) OPTICAL COMMUNICATION APPARATUS

(71) Applicant: SUMITOMO ELECTRIC INDUSTRIES, LTD., Osaka (JP)

(72) Inventors: Koichi KOYAMA, Yokohama-shi (JP); Akira FURUYA, Hadano-shi (JP)

(73) Assignee: SUMITOMO ELECTRIC INDUSTRIES, LTD., Osaka (JP)

(21) Appl. No.: 15/244,323

(22) Filed: Aug. 23, 2016

(30) Foreign Application Priority Data
Aug. 26, 2015 (JP) 2015-166713

(51) Int. Cl. G02B 6/42; G02B 6/30

(52) U.S. Cl. CPC G02B 6/421; G02B 6/4292; G02B 6/4244; G02B 6/423; G02B 6/4239; G02B 6/4249; G02B 6/30

(57) ABSTRACT

An optical communication apparatus includes a fiber stub, a planar waveguide device optically connected to the fiber stub, and a resin body. The fiber stub includes a holder and an optical fiber held by the holder, the holder having first and second portions arranged along a first reference plane. The resin body connects the planar waveguide device to the fiber stub. The first portion of the holder has first and second end faces, and has a first hole for the optical fibers extending from first to second end faces. The second portion of the holder has third and fourth end faces, and has a second hole for a guide pin. A first distance between the first and the second end faces is larger than a second distance between the third and fourth end faces.

### BACKGROUND OF THE INVENTION

1. Field of the Invention

The present invention relates to an optical communication apparatus.

2. Description of the Related Art

Japanese Unexamined Patent Application Publication No. 2012-93536 discloses an optical module that is connected to an MT connector for optical connection.

By inserting a pair of guide pins, which are fixed to a base, into a pair of holes formed in the MT connector, an optical waveguide in the base is optically connected to an optical fiber in the MT connector.

An optical module can perform input and output of an optical signal through, for example, a pigtail-type optical connector. It is required that the pigtail-type optical connector can be attached to and removed from a surface of a substrate, while it is also required that the pigtail-type optical connector can be securely fixed to the substrate. To satisfy both of these requirements, instead of fixing the pigtail-type optical connector to the substrate directly, the pigtail-type optical connector is fixed to the substrate using a fiber stub. In this form of connection, the fiber stub is attached to the surface of the substrate by using, for example, an adhesive. One facet of the fiber stub is fixed to the substrate with the adhesive.

### SUMMARY OF THE INVENTION

According to the inventor's findings, after one facet of a fiber stub was fixed to a surface of a substrate with an adhesive by performing active alignment using a pigtail-type optical connector, the adhesive tends to adhere to the other facet of the fiber stub. Even when one facet of the fiber stub was fixed to the substrate sufficiently carefully so as to prevent the adhesive from directly adhering to the other facet of the fiber stub, it was difficult to avoid adherence of the adhesive to the other facet, after the one facet of the fiber stub was fixed to the substrate with the adhesive.

The inventor performed observation that revealed the mechanism by which the adhesive adheres to the other facet of the fiber stub.

A optical communication apparatus according to an aspect of the present invention includes a fiber stub including a holder and an optical fiber held by the holder, the holder having a first portion and a second portion that are arranged along a first reference plane; a planar waveguide device including an optical coupler, an optical waveguide connected to the optical coupler, and a semiconductor optical device connected to the optical waveguide; and a resin body disposed between the planar waveguide device and the fiber stub. The first portion of the holder includes a first end face, a second end face on an opposite side to the first end face, and a first hole extending from the first end face to the second end face in a first direction. The second portion of the holder includes a third end face, a fourth end face on an opposite side to the third end face, and a second hole extending from the third end face to the fourth end face. The first end face and the third end face intersect the first reference plane. The optical fiber extends from the first end face of the holder through the first hole. The first end face and the second end face are arranged with a first distance that is larger than a second distance between the third end face and the fourth end face.

A optical communication apparatus according to another aspect of the present invention includes fiber stub including a holder and an optical fiber held by the holder, the holder having a first portion and a second portion that are arranged along a first reference plane; a planar waveguide device including an optical coupler, an optical waveguide connected to the optical coupler, and a semiconductor optical device connected to the optical waveguide; a resin body disposed between the planar waveguide device and the fiber stub; and a guiding portion embedded in the second portion of the holder. The first portion of the holder includes a first end face, a second end face on an opposite side to the first end face, and a first hole extending from the first end face to the second end face in a first direction. The second portion of the holder includes a third end face, a fourth end face on an opposite side to the third end face, and a second hole extending from the third end face to the fourth end face. The first and third end faces constitute a first facet of the fiber stub. The second and fourth end faces constitute a second facet of the fiber stub. The optical fiber extends from the first end face of the holder through the first hole. The guiding portion extends through the second hole. The guiding portion includes one end, the other end, and a hole that extends from the one end in the first direction and that terminates at a position between the one end and the other end.

The aforementioned object, other objects, features, and advantages of the present invention will become clear from the detailed description of preferred embodiments of the present invention, which will be given below with reference to the drawing.

As described above, with an aspect of the present invention, a fiber stub that can reduce flow of a resin from one facet to another facet is provided. With another aspect of the present invention, an optical communication apparatus including the fiber stub that can reduce flow of a resin from one facet to another facet is provided.

### BRIEF DESCRIPTION OF THE DRAWINGS

FIG. 1 is a schematic view illustrating a structure for a fiber stub according to an embodiment.

FIG. 2 is a schematic view illustrating another structure for a fiber stub according to the embodiment.

FIG. 3 illustrates components of the fiber stub shown in FIG. 1

FIG. 4 illustrates components of the fiber stub shown in FIG. 2

FIG. 5 is a schematic view illustrating an optical communication apparatus including the fiber stub shown in FIG. 1 and according to the embodiment.

FIG. 6 is a schematic view illustrating an optical communication apparatus including the fiber stub shown in FIG. 2 and according to the embodiment.

FIG. 7 is a plan view illustrating an example of an optical integrated device for the optical communication apparatus according to the embodiment.

FIG. 8 is a schematic view illustrating a still another structure for a fiber stub according to the embodiment.

FIG. 9 is a schematic view illustrating an optical communication apparatus including the fiber stub shown in FIG. 8 and according to the embodiment.

FIG. 10A is a schematic view illustrating a main step of a method of making an optical communication apparatus according to the embodiment.

FIG. 10B is a schematic view illustrating a main step of the method of making the optical communication apparatus according to the embodiment.

FIG. 10C is a schematic view illustrating a main step of the method of making the optical communication apparatus according to the embodiment.

FIG. 11A is a schematic view illustrating a main step of the method of making the optical communication apparatus according to the embodiment.

FIG. 11B is a schematic view illustrating a main step of the method of making the optical communication apparatus according to the embodiment.

FIG. 11C is a schematic view illustrating a main step of the method of making the optical communication apparatus according to the embodiment.

FIG. 12A is a schematic view illustrating a main step of a method of making another optical communication apparatus according to the embodiment.

FIG. 12B is a schematic view illustrating a main step of the method of making the other optical communication apparatus according to the embodiment.

FIG. 12C is a schematic view illustrating a main step of the method of making the other optical communication apparatus according to the embodiment.

FIG. 13A is a schematic view illustrating a main step of the method of making the other optical communication apparatus according to the embodiment.

FIG. 13B is a schematic view illustrating a main step of the method of making the other optical communication apparatus according to the embodiment.

FIG. 14A is a schematic view illustrating a main step of the method of making the other optical communication apparatus according to the embodiment.

FIG. 14B is a schematic view illustrating a main step of the method of making the other optical communication apparatus according to the embodiment.

FIG. 14C is a schematic view illustrating a main step of the method of making the other optical communication apparatus according to the embodiment.

FIG. 15A is a schematic view illustrating a main step of a method of making still another optical communication apparatus according to the embodiment.

FIG. 15B is a schematic view illustrating a main step of the method of making the still other optical communication apparatus according to the embodiment.

FIG. 15C is a schematic view illustrating a main step of the method of making the still other optical communication apparatus according to the embodiment.

FIG. 16A is a schematic view illustrating a main step of the method of making the still other optical communication apparatus according to the embodiment.

FIG. 16B is a schematic view illustrating a main step of the method of making the still other optical communication apparatus according to the embodiment.

FIG. 16C is a schematic view illustrating a main step of the method of making the still other optical communication apparatus according to the embodiment.

### DESCRIPTION OF THE PREFERRED EMBODIMENTS

Hereinafter, some embodiments will be described. An optical communication apparatus according to an embodiment includes (a) a fiber stub including a holder and an optical fiber held by the holder, the holder having a first portion and a second portion that are arranged along a first reference plane, (b) a planar waveguide device including an optical coupler, an optical waveguide connected to the optical coupler, and a semiconductor optical device connected to the optical waveguide, and (c) a resin body disposed between the planar waveguide device and the fiber stub. The first portion of the holder includes a first end face, a second end face on an opposite side to the first end face, and a first hole extending from the first end face to the second end face in a first direction. The second portion of the holder includes a third end face, a fourth end face on an opposite side to the third end face, and a second hole extending from the third end face to the fourth end face. The first end face and the third end face intersect the first reference plane. The optical fiber extends from the first end face of the holder through the first hole. The first end face and the second end face are arranged with a first distance that is larger than a second distance between the third end face and the fourth end face.

With the optical communication apparatus, the optical fiber extends from the first end face of the first portion of the holder through the first hole. The optical fiber of the fiber stub is optically connected to the optical coupler of the planar waveguide device through the first end face of the fiber stub. The optical fiber of the fiber stub is optically connected to an optical connector through the second end face of the fiber stub. To optically connect the fiber stub to the planar waveguide device, the optical fiber is aligned with the optical coupler, and a resin body is applied between the first end face and a surface of the optical coupler. To optically connect the fiber stub to the optical connector, the optical connector is aligned with the fiber stub by inserting a guide pill into the second hole. The resin body applied to the first end face has fluidity before it is cured, and the resin body spreads not only on the first end face of the first portion but also toward the second portion of the fiber stub.

According to the inventor's findings, the spread resin body may flow into a gap between the inner side surface of the second hole and the side surface of the guide pin due to capillary action. If the resin body would reach the second end face, optical connection between the fiber stub and the optical connector would be disturbed by the resin body. In the above-mentioned fiber stub, the first distance between the first and second end faces is larger than the the second distance between the third and fourth end faces. In other words, a length of the second hole is shorter than the first distance. Thus, the resin body on the first end face cannot reach the second end face through the second hole.

In an optical communication apparatus according to an embodiment, the first end face and the third end face are arranged along a third reference plane, and constitute a first facet of the fiber stub. The second end face extends along a second reference plane. The fourth end face is arranged so as to be set back from the second end face in the first direction.

With the optical communication apparatus, an embodiment in which the first end face and the third end face of the holder are arranged along the third reference plane, which intersects the first direction, and constitute the first facet of the fiber stub is provided. According to the above-described fiber stub, the resin body applied on the first end face may spread into the third end face, and may reach the fourth end face through the second hole due to the capillary action. Even when the resin body would reach the fourth end face, the resin body does not reach the second end face because the second end face is separated from the fourth end face owing to a set-back portion between them.

In an optical communication apparatus according to an embodiment, the second end face and the fourth end face are arranged along a second reference plane, and constitute a second facet of the fiber stub. The first end face extends along a third reference plane. The third end face is arranged so as to be set back from the first end face in the first direction.

With the optical communication apparatus, an embodiment in which the second end face and the fourth end face of the holder are arranged along the second reference plane, which intersects the first direction, and constitute the second facet of the fiber stub is provided. According to the above-described fiber stub, the resin body applied on the first end face does not spread into the third end face, because the third end face is separated from the first end face owing to a set-back portion between them. Thus, the resin body applied to the first end face does not contaminate the second end face.

In an optical communication apparatus according to an embodiment, the holder further includes a third portion including a fifth end face, a sixth end face on an opposite side to the fifth end face, and a third hole extending from the fifth end face to the sixth end face. The first portion is positioned between the second portion and the third portion. The first hole, the second hole, and the third hole are arranged along the first reference plane. The fifth end face and the sixth end face are arranged with a third distance that is smaller than the first distance between the first end face and the second end face.

With the optical communication apparatus, the distance between the fifth end face and the sixth end face at the position of the third hole is smaller than the distance between the first end face and the second end face at the position of the first hole. For example, with a structure in which the first end face and the fifth end face of the holder are arranged along a third reference plane, which intersects the first direction, and constitute the first facet of the fiber stub, the resin may reach the sixth end face through the third hole of the fifth end face of the first facet due to capillary action. However, because the second end face, which is positioned on the opposite side to the first end face, is separated from the sixth end face, which is positioned on the opposite side to the fourth end face, the resin on the sixth end face does not reach the second end face. With a structure in which the second end face and the sixth end face are arranged along a second reference plane, which intersects the first direction, and constitute the second facet of the fiber stub, the resin on the first end face does not reach the inlet of the second hole of the fifth end face, because the fifth end face is separated from the first end face.

An optical communication apparatus according to an embodiment further includes a guide pin including a portion that is positioned in the second hole.

With the optical communication apparatus, the guide pin is fixed to the fiber stub, and it is easy to optically connect the fiber stub and the optical connector to each other.

An optical communication apparatus according to an embodiment includes (a) fiber stub including a holder and an optical fiber held by the holder, and a guiding portion embedded in the second portion of the holder, the holder having a first portion and a second portion that are arranged along a first reference plane (b) a planar waveguide device including an optical coupler, an optical waveguide connected to the optical coupler, and a semiconductor optical device connected to the optical waveguide, (c) a resin body disposed between the planar waveguide device and the first portion of the fiber stub, and (d) a guiding portion embedded in the second portion of the holder. The first portion of the holder includes a first end face, a second end face on an opposite side to the first end face, and a first hole extending from the first end face to the second end face in a first direction. The second portion of the holder includes a third end face, a fourth end face on an opposite side to the third end face, and a second hole extending extending from the third end face to the fourth end face. The first end face and the third end face constitute a first facet of the fiber stub. The second end face and the fourth end face constitute a second facet of the fiber stub. The optical fiber extends from the first end face of the holder through the first hole. The guiding portion extends through the second hole. The guiding portion includes one end, the other end, and a hole that extends from the one end in the first direction and terminates at a position between the one end and the other end.

With the optical communication apparatus, the optical fiber extends from the first end face of the first portion of the holder through the first hole. The optical fiber of the fiber stub is optically connected to the optical coupler of the planar waveguide device through the first end face of the fiber stub. The optical fiber of the fiber stub is optically connected to an optical connector through the second end face of the fiber stub. To optically connect the fiber stub to the optical coupler, the optical fiber is actively aligned with the optical coupler, and a resin body is applied between the first end face of the fiber stub and a surface of the planar waveguide device. To connect the fiber stub and the optical connector to each other, the fiber stub is aligned with the optical connector by inserting a guide pin into a hole extending from one end of the guiding portion of the second hole. The applied resin body to the first end face has fluidity before it is cured, and the resin body spreads not only on the first end face of the first portion but also toward the second portion.

According to the inventor's findings, because the spread resin body flows into a gap between components due to capillary action, the applied resin body may be absorbed into gaps related to the second hole and/or the guiding portion. If the resin body would reach the second end face, optical connection between the fiber stub and the optical connector would be disturbed by the resin body. With the above-mentioned fiber stub, because the hole of the guiding portion terminates at a position between the one end and the other end, it is possible to prevent the resin body, which has spread to the third end face of the second portion, from reaching the fourth end face through the hole of the guiding portion.

In an optical communication apparatus according to an embodiment, the guiding portion includes a guide pipe and a sealing member. The guide pipe includes a via-hole penetrating through the guide pipe. The sealing member is arranged in the via-hole. The sealing member is in contact with an inner surface of the via-hole.

With the optical communication apparatus, the hole of the guiding portion is terminated by the sealing member, which blocks the resin body in the via-hole. The sealing member prevents the resin body applied to the first facet from reaching the second facet of the fiber stub.

The findings underlying the present invention can be easily understood by considering the following detailed description with reference to the drawings, which are shown as examples. Fiber stubs and optical communication apparatuses according to embodiments will be described below in further detail with reference to the drawings. Where possible, the same portions will be denoted by the same numerals.

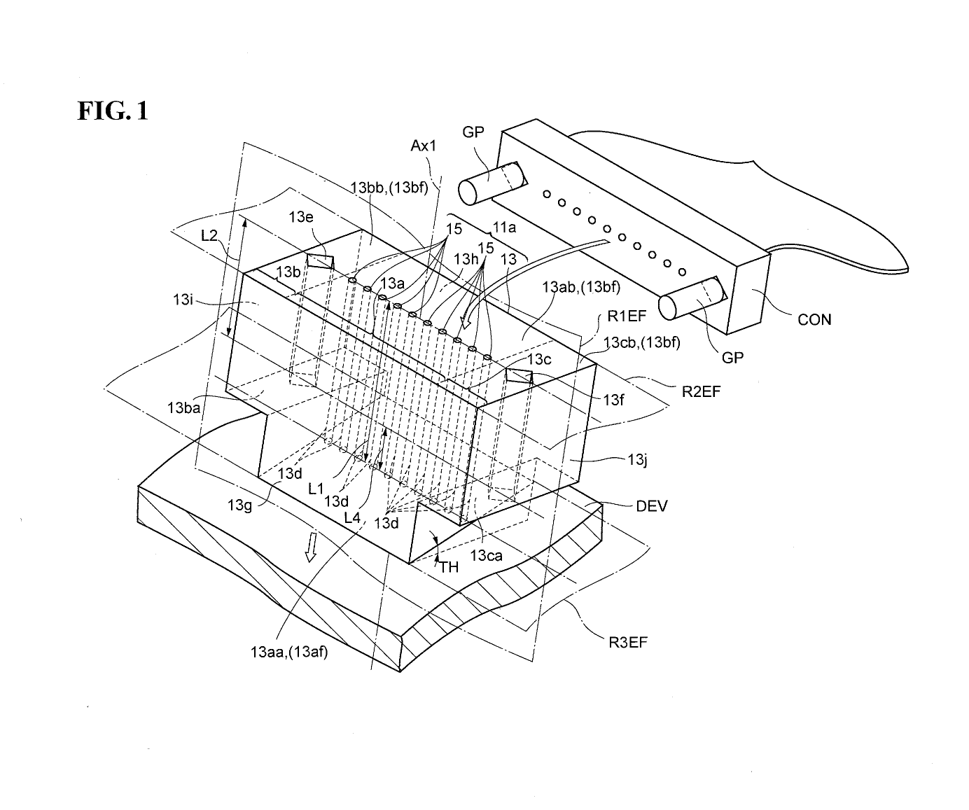

FIG. 1 is a schematic view illustrating a fiber stub according to an embodiment. A fiber stub 11a includes a holder 13 and one or more optical fibers 15. (In the present embodiment, the number of the optical fibers 15 is ten.) The holder 13 includes a first portion 13a and a second portion 13b, which are arranged along a first reference plane R1EF. In the present embodiment, the first portion 13a and the second portion 13b are positioned adjacent to each other. The optical fibers 15 are held by the holder 13. The fiber stub 11a is disposed on a planar waveguide device DEV.

The first portion 13a of the holder 13 includes a first end face 13aa and a second end face 13ab, and the second end face 13ab is located on the opposite side to the first end face 13aa. The first portion 13a includes one or more first holes 13d. (In the present embodiment, the number of the first holes 13d is ten.) The first holes 13d extend from one to the other of the first end face 13aa and the second end face 13ab in a first direction Ax1. The optical fibers 15 extend from the first end face 13aa of the holder 13 through the first holes 13d. The first end face 13aa is coupled to a surface of the planar waveguide device DEV, and a resin body (not shown) is disposed between the first end face 13aa and the surface of the planar waveguide device DEV.

The second portion 13b of the holder 13 includes a third end face 13ba and a fourth end face 13bb. The fourth end face 13bb is located on the opposite side to the third end face 13ba. The second portion 13b includes a second hole 13e. (In the present embodiment, the number of the second hole 13e is one.) The second hole 13e extends from one to the other of the third end face 13ba and the fourth end face 13bb in the first direction Ax1. The second hole 13e is formed for a guide pin that is used for alignment when connecting the fiber stub 11a to an optical connector CON.

The first end face 13aa and the second end face 13ab intersect the first reference plane R1EF, and the third end face 13ba and the fourth end face 13bb interest the first reference plane R1EF. The distance between the first end face 13aa and the second end face 13ab at the positions of the first holes 13d of the first portion 13a is a first length (i.e. a first distance) L1, and the distance between the third end face 13ba and the fourth end face 13bb at the position of the second hole 13e of the second portion 13b is a second length (i.e. a second distance) L2. The second length L2 is smaller than the first length L1. The first length L1 and the second length L2 are measured in the first direction Ax1.

In the present embodiment, the first holes 13d are arranged along the first reference plane R1EF. The optical fibers 15 are arranged along the first reference plane R1EF and constitute an optical fiber array.

In the fiber stub 11a illustrated in FIG. 1, the second end face 13ab and the fourth end face 13bb are arranged so as to intersect the first reference plane R1EF. To be specific, the second end face 13ab and the fourth end face 13bb extend along a second reference plane R2EF, which intersects both the first reference plane R1EF and the first direction Ax1. The second end face 13ab and the fourth end face 13bb constitute a second facet 13bf. The first end face 13aa extends along a third reference plane R3EF. The third end face 13ba is arranged so as to be set back from the first end face 13aa in the first direction Ax1.

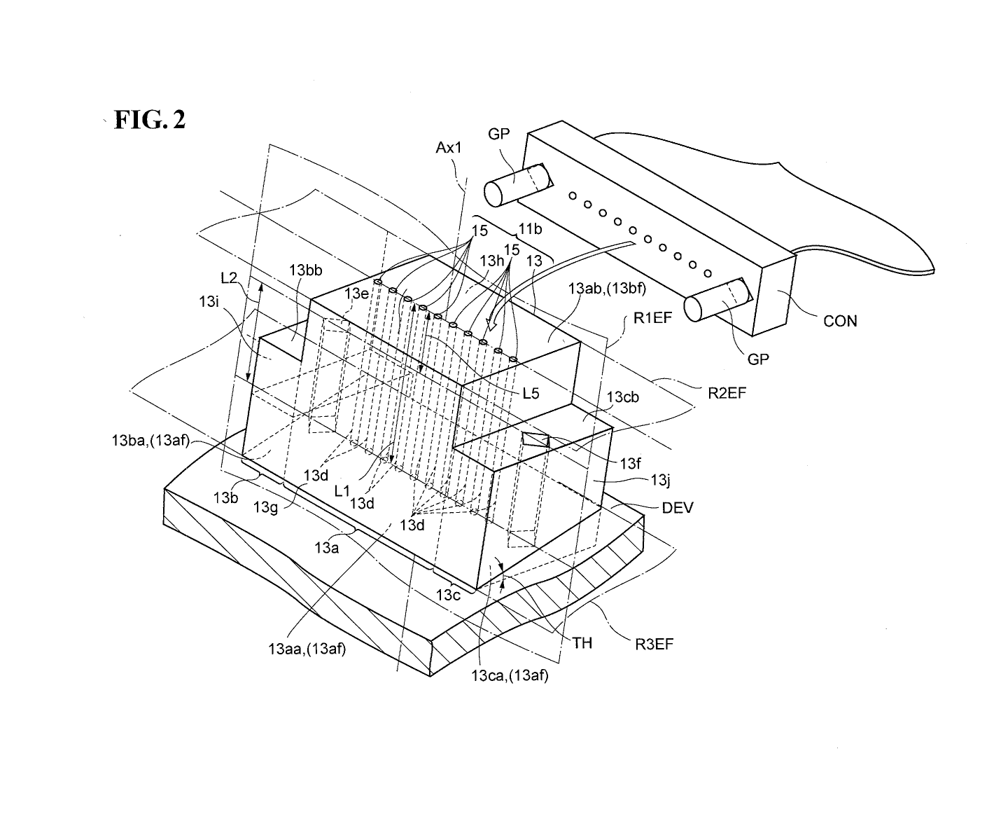

FIG. 2 is a schematic view illustrating another fiber stub according to the present embodiment. As with the fiber stub 11a, a fiber stub 11b includes a holder 13 and one or more optical fibers 15. (In the present embodiment, the number of the optical fibers 15 is ten.) The holder 13 includes a first portion 13a and a second portion 13b, which are arranged along a first reference plane R1EF. The optical fibers 15 are held by the holder 13. The fiber stub 11b is disposed on a planar waveguide device DEV.

The distance between the first end face 13aa and the second end face 13ab at the positions of the first holes 13d of the first portion 13a is a first length (i.e. a first distance) L1, and the distance between the third end face 13ba and the fourth end face 13bb at the position of the second hole 13e of the second portion 13b is a second length (i.e. a second distance) L2. The second length L2 is smaller than the first length L1.

The first end face 13aa and the second end face 13ab intersect the first reference plane R1EF, and the third end face 13ba and the fourth end face 13bb interest the first reference plane R1EF. In the fiber stub 11b illustrated in FIG. 2, the first end face 13aa and the third end face 13ba are arranged so as to intersect the first reference plane R1EF. To be specific, the first end face 13aa and the third end face 13ba extend along a third reference plane R3EF, which intersects both the first reference plane R1EF and the first direction Ax1. The first end face 13aa and the third end face 13ba constitute a first facet 13af. The second end face 13ab extends along a second reference plane R2EF. The fourth end face 13cb is is arranged so as to be set back in the first direction from the second end face 13ab. In the present embodiment, the holder 13 of the fiber stub 11b differs from the holder 13 of the fiber stub 11a in the following respects: the holder of the fiber stub 11b includes the first facet 13af that is constituted by the first end face 13aa and the third end face 13ba, while the holder 13 of the fiber stub 11b includes the second facet 13bf that is constituted by the second end face 13ab and the fourth end face 13bb.

With the fiber stubs 11a and 11b, the optical fibers 15 extend from the first end face 13aa of the first portion 13a of the holder 13 through the first holes 13d. The optical fibers 15 of the fiber stubs 11a and 11b are optically connected to optical couplers of the planar waveguide device DEV through the first end face 13aa.

To optically connect the fiber stubs 11a and 11b and the planar waveguide device DEV, the fiber stubs 11a and 11b are actively aligned with the planar waveguide device DEV. After the active alignment, a resin body is applied to a small gap between the first end face 13aa and a surface of the planar waveguide device DEV. Subsequently, the resin body is cured in order to rigidly fix the fiber stubs 11a and 11b to the surface of the planar waveguide device DEV. To optically connect the fiber stubs 11a and 11b and the optical connector CON to each other, the fiber stubs 11a and 11b are aligned with the optical connector CON by using a guide pin GP inserted in the second hole 13e, and an adhesive is applied to the second end face 13ab.

The applied resin body to the first end portion 13aa has fluidity before it is cured, and the resin body spreads not only on the first end face 13aa of the first portion 13a but also toward the second portion 13b. According to the inventor's findings, the spread resin body may flow into a gap between components due to capillary action. The applied resin body may flow into a gap between the inner side surface of the second hole 13e and the side surface of the guide pin GP. In the fiber stub of the present embodiment, the facet distance of the second portion 13b (the distance between the third end face 13ba and the fourth end face 13bb, the second length L2) at the position of the second hole 13e is smaller than the facet distance of the first portion 13a (the distance between the first end face 13aa and the second end face 13ab, the first length L1) at the positions of the first holes 13d. Owing to the difference between the lengths, it is possible to prevent a resin body applied to the first end face 13aa from reaching the second end face 13ab, and from disturbing the optical connection at the second end face 13ab (optical connection between the optical connector and the fiber stub).

For example, in a fiber stub (for example, the fiber stub 11a), the third end face 13ba of the holder 13 is set back with respect to the first end face 13aa by a fourth length L4 in the first direction Ax1. Owing to the partial setback of the facet, the resin body applied to the first end face 13aa does not reach the third end face 13ba by only spreading (spreading in the lateral direction) of the resin body. Therefore, because the first portion 13a, including the first end face 13aa, protrudes in the first direction Ax1 with respect to the third end face 13ba, the resin body on the first end face 13aa does not reach an inlet of the second hole 13e of the third end face 13ba.

For another example, in a fiber stub (for example, the fiber stub 11b), the fourth end face 13bb of the holder 13 is set back with respect to the second end face 13ab by a fifth length L5 in the first direction Ax1. The resin body applied to the first end face 13aa may reach the third end face 13ba by spreading in the lateral direction, and the resin body on the third end face 13ba may reach the fourth end face 13bb, which is located on the opposite side to the third end face 13ba, through the second hole 13e of the third end face 13ba. The resin body that has reached the fourth end face 13bb through the second hole 13e does not reach the second end face 13ab, because the first portion 13a, including the second end face 13ab, protrudes in the first direction Ax1 with respect to the fourth end face 13bb.

In the fiber stubs 11a and 11b, the holder 13 further includes a third portion 13c. In the holder 13, the first portion 13a, the second portion 13b, and the third portion 13c are arranged along the first reference plane R1EF; the first portion 13a is positioned between the second portion 13b and the third portion 13c; and the first portion 13a, the second portion 13b, and the third portion 13c are integrated so as to form the holder 13. The third portion 13c includes a fifth end face 13ca and a sixth end face 13cb. The sixth end face 13cb is located on the opposite side to the fifth end face 13ca. The third portion 13c includes a third hole 13f extending from the fifth end face 13ca to the sixth end face 13cb in the first direction Ax1. The distance between the fifth end face 13ca and the sixth end face 13cb at the position of the third hole 13f of the third portion 13c is a third length L3, and the third length L3 is smaller than the first length L1. In the present embodiment, the first holes 13d, the second hole 13e, and the third hole 13f are arranged along the first reference plane R1EF. In a specific example, the third length L3 is substantially the same as the second length L2.

With the fiber stubs 11a and 11b, the facet distance of the third portion 13c (the distance between the fifth end face 13ca and the sixth end face 13cb, the third length L3) at the position of the third hole 13f is smaller than the facet distance of the first portion 13a (the distance between the first end face 13aa and the second end face 13ab, the first length L1) at the positions of the first holes 13d of the first portion 13a. With the fiber stubs 11a and 11b, the third hole 13f of the third portion 13c produces a technical effect in the same way as the second hole 13e of the second portion 13b does because of the structure thereof.

In a fiber stub (for example, the fiber stub 11a) in which the fifth end face 13ca of the holder is set back with respect to the first end face 13aa in the first direction Ax1 (by, for example, the fourth length L4), owing to the partial setback of the facet, the resin body applied to the first end face 13aa does not reach the fifth end face 13ca by only spreading (spreading in the lateral direction) of the resin body. Therefore, because the first end face 13aa protrudes in the first direction Ax1 with respect to the fifth end face 13ca, the resin body on the first end face 13aa does not reach an inlet of the third hole 13f of the fifth end face 13ca.

In another fiber stub (for example, the fiber stub 11b) in which the sixth end face 13cb of the holder is set back with respect to the second end face 13ab in the first direction Ax1 (by, for example, the fifth length L5), the resin body applied to the first end face 13aa may spread in the lateral direction and may reach the fifth end face 13ca. Then, the resin body may reach the sixth end face 13cb, which is located on the opposite side to the fifth end face 13ca, through the third hole 13f of the fifth end face 13ca. The resin body that has reached the sixth end face 13cb through the third hole 13f does not reach the second end face 13ab, because the first portion 13a, including the second end face 13ab, protrudes in the first direction Ax1 with respect to the sixth end face 13cb.

The dimensions of the holder may be, for example, as follows. The first length L1 may be 3 mm. The first length L1 may be in the range of 2 to 8 mm. The second length L2 and the third length L3 may each be 2 mm. The second length L2 or the third length L3 may be in the range of 1.5 to 7.5 mm. The fourth length L4 may be 1 mm. The fourth length L4 may be in the range of 0.5 to 2 mm. The fifth length L5 may be 1 mm. The fifth length L5 may be in the range of 0.5 to 2 mm.

Referring to FIG. 1, the second end face 13ab, the fourth end face 13bb, and the sixth end face 13cb are arranged along the second reference plane R2EF, which intersects the first direction, and constitute the second facet 13bf of the fiber stub 11a. With the fiber stub 11a, because the third end face 13ba and the fifth end face 13ca are both set back with respect to the first end face 13aa, a resin body on the first end face 13aa does not reach an inlet of the second hole 13e of the third end face 13ba and an inlet of the third hole 13f of the fifth end face 13ca. The first end face 13aa extends along the third reference plane R3EF, and the third end face 13ba and the fifth end face 13ca are separated from the third reference plane R3EF. In a specific example, the third reference plane R3EF may be inclined with respect to a plane perpendicular to the first direction Ax1. When the first end face 13aa is inclined, the fiber stub 11a can be optically connected to the external component DEV reliably. The inclination angle TH of the first end face 13aa may be, for example, in the range of 6 to 10 degrees.

Referring to FIG. 2, the first end face 13aa, the third end face 13ba, and the fifth end face 13ca are arranged along the third reference plane R3EF, which intersects the first direction, and constitute the first facet 13af of the fiber stub 11b. With the fiber stub 11b, the fourth end face 13bb and the sixth end face 13cb are both set back with respect to the second end face 13ab. A resin on the first end face 13aa may reach the fourth end face 13bb and the sixth end face 13cb through the second hole 13e of the third end face 13ba and through the third hole 13f of the fifth end face 13ca. The resin body on the fourth end face 13bb and the sixth end face 13cb does not reach the second end face 13ab, because the second end face 13ab extends along the second reference plane R2EF and the fourth end face 13bb and the sixth end face 13cb are separated from the second reference plane R2EF. In a specific example, the third reference plane R3EF may be inclined with respect to a plane perpendicular to the first direction Ax1. When the first end face 13aa and the first facet 13af are inclined, the fiber stub 11b can be optically connected to the external component DEV reliably. The inclination angle TH of the first facet 13af may be, for example, in the range of 6 to 10 degrees.

Each of the fiber stubs 11a and 11b includes a first side surface 13g, a second side surface 13h, a third side surface 13i, and a fourth side surface 13j. The first side surface 13g, the second side surface 13h, the third side surface 13i, and the fourth side surface 13j extend in the first direction Axl. The first side surface 13g is positioned on the opposite side to the second side surface 13h, and the third side surface 13i is positioned on the opposite side to the fourth side surface 13j. The first portion 13a, the second portion 13b, and the third portion 13c are arranged in a direction from one to the other of the third side surface 13i and the fourth side surface 13j. The first end face 13aa extends from an edge of one of the first side surface 13g and the second side surface 13h to an edge of the other of the first side surface 13g and the second side surface 13h. The first end face 13aa, which has a large width connecting the two side surfaces, enables the fiber stub 11a to be optically connected to the device DEV with a stable optical connection angle.

In the present embodiment, the third end face 13ba and the fifth end face 13ca of the fiber stub 11a extend from edges of one of the first side surface 13g and the second side surface 13h to edges of the other of the first side surface 13g and the second side surface 13h. The third end face 13ba and the fifth end face 13ca, which have a large width connecting the two side surfaces, can reduce the probability that a resin body on the first end face 13aa flows along sides of the first end face 13aa and accidentally reaches the second hole 13e of the third end face 13ba and the third hole 13f of the fifth end face 13ca. The third end face 13ba extends to the third side surface 13i over the entirety of the second portion 13b, and the fifth end face 13ca extends to the fourth side surface 13j over the entirety of the third portion 13c. The third end face 13ba and the fifth end face 13ca, which include setback portions extending to the side surfaces and having a large size, can reduce the probability that a resin body on the first end face 13aa overflows and accidentally reaches the second hole 13e of the third end face 13ba and the third hole 13f of the fifth end face 13ca.

In the present embodiment, the fourth end face 13bb and the sixth end face 13cb of the fiber stub 11b extend from edges of one of the first side surface 13g and the second side surface 13h to edges of the other of the first side surface 13g and the second side surface 13h. The fourth end face 13bb and the sixth end face 13cb, which have a large width connecting the two side surfaces, can reduce the probability that a resin from the, second hole 13e of the fourth end face 13bb and the third hole 13f of the fifth end face 13ca overflows from the fourth end face 13bb and the sixth end face 13cb and accidentally reaches the second end face 13ab. The fourth end face 13bb extends to the third side surface 13i over the entirety of the second portion 13b, and the sixth end face 13cb extends to the fourth side surface 13j over the entirety of the third portion 13c. The fourth end face 13bb and the sixth end face 13cb, which include setback portions extending to the side surfaces and having a large size, can reduce the probability that a resin body from the second hole 13e of the third end face 13ba and the third hole 13f of the fifth end face 13ca overflows from the third end face 13ba and the fifth end face 13ca and reaches the second end face 13ab.

The fiber stubs 11a and 11b illustrated FIGS. 1 and 2 are typical examples of a fiber stub, and a fiber stub according to the present embodiment is not limited to these examples.

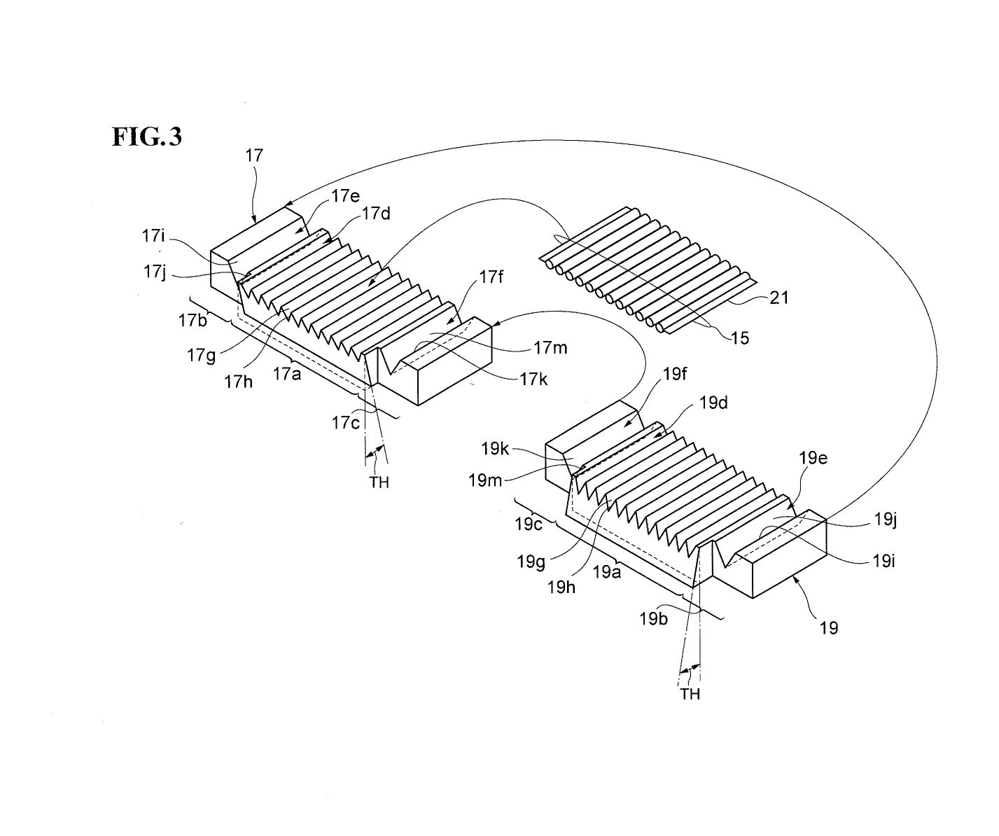

FIG. 3 illustrates the structure of the fiber stub 11a shown in FIG. 1. The holder 13 may include a first member 17 and a second member 19. The second member 19 may have substantially the same structure as the first member 17. In the present embodiment, the first member 17 will be mainly described while referring to the numerals for the first member 17 and the second member 19. The first member 17 (the second member 19) includes a first portion 17a (19a), a second portion 17b (19b), and a third portion 17c (19c). The first portion 17a (19a) is disposed between the second portion 17b (19b) and the third portion 17c (19c). The first member 17 (the second member 19) includes first support portions 17d (19d), for supporting the optical fibers 15; and a second support portion 17e (19e) and a third support portion 17f (19f), for supporting the guide pins GP. Each of the first support portions 17d (19d) includes support surfaces 17g and 17h (19g and 19h) for supporting a corresponding one of the optical fibers 15. When the first member 17 and the second member 19 are assembled together, the support surfaces 17g and 17h (19g and 19h) form the first holes 13d. Each of the optical fibers 15 is supported by the support surfaces 17g and 17h (19g and 19h) of a corresponding one of the first support portions 17d (19d) and fixed in place between the first member 17 and the second member 19 by using an adhesive 21. The second support portion 17e (19e) includes guide surfaces 17i and 17j (19i and 19j) for guiding the guide pin GP. When the first member 17 and the second member 19 are assembled together, the guide surfaces 17i and 17j (19i and 1j) form the second hole 13e. The third support portion 17f (19f) includes guide surfaces 17k and 17m (19k and 19m) for guiding the guide pin GP. When the first member 17 and the second member 19 are assembled together, the guide surfaces 17k and 17m (19k and 19m) form the third hole 13f.

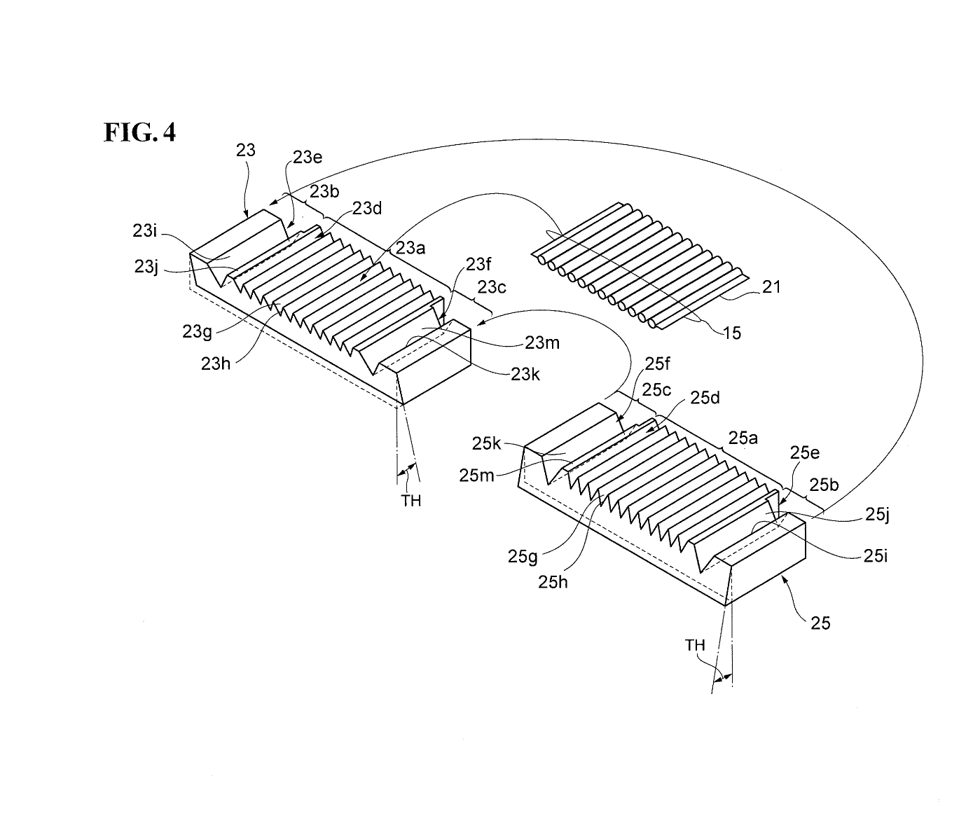

FIG. 4 illustrates the structure of the fiber stub 11b shown in FIG. 2. The holder 13 may include a first member 23 and a second member 25. The second member 25 may have substantially the same structure as the first member 23. In the present embodiment, the first member 23 will be mainly described while referring to the numerals for the first member 23 and the second member 25. The first member 23 (the second member 25) includes a first portion 23a (25a), a second portion 23b (25b), and a third portion 23c (25c). The first portion 23a (25a) is disposed between the second portion 23b (25b) and the third portion 23c (25c). The first member 23 (the second member 25) includes first support portions 23d (25d), for supporting the optical fibers 15; and a second support portion 23e (25e) and a third support portion 23f (25f), for supporting the guide pins GP. Each of the first support portions 23d (25d) includes support surfaces 23g and 23h (25g and 25h) for supporting a corresponding one of the optical fibers 15. When the first member 23 and the second member 25 are assembled together, the support surfaces 23g and 23h (25g and 25h) form the first holes 13d. Each of the optical fibers 15 is supported by the support surfaces 23g and 23h (25g and 25h) of a corresponding one of the first support portions 23d (25d) and fixed in place between the first member 23 and the second member 25 using an adhesive 21. The second support portion 23e (25e) includes guide surfaces 23i and 23j (25i and 25j) for guiding the guide pin GP. When the first member 23 and the second member 25 are assembled together, the guide surfaces 23i and 23j (25i and 25j) form the second hole 13e. The third support portion 23f (25f) includes guide surfaces 23k and 23m (25k and 25m) for guiding the guide pin GP. When the first member 23 and the second member 25 are assembled together, the guide surfaces 23k and 23m (25k and 25m) form the third hole 13f.

For example, the first support portions 17d (19d) and the first support portions 23d (25d) may be V-shaped grooves that support the optical fibers 15. The second support portion 17e (19e), the third support portion 17f (19f), the second support portion 23e (25e), and the third support portion 23f (25f) may be V-shaped grooves that can guide the guide pins GP.

A method of making the holder 13 will be described simply. To make a holder for an optical fiber array stub, a glass plate (made of, for example, TEMPAX Float® or Pyrex®) is prepared. V-shaped grooves, for supporting optical fibers, and V-shaped grooves, for inserting guide pins, are cut in the glass plate. These V-shaped grooves extend in the same direction. The glass plate, in which the grooves have been formed, is cut into pieces, each having a length of about 3 mm, so as to make a large number of components (components for the first members and the second members). An assembly is formed by sandwiching optical fibers and an adhesive, including an ultraviolet polymerization initiator, between a pair of the components, which have been made as described above. Then, the adhesive is cured by irradiating the assembly with ultraviolet rays. Subsequently, one end and other end of the assembly are polished to form an optical connection facet and a setback facet of the optical fiber array stub. An end portion of an optical fiber array is positioned at the optical connection facet, and openings of the second hole and the third hole for the guiding portions are positioned at the setback facet. In the present embodiment, the length of each of the optical fiber support grooves is, for example, 3 mm; and the length of each of the guiding portion support grooves is, for example, 2.5 mm. The distance between the first side surface and the second side surface of the holder is, for example, 3 mm; and the distance between third side surface and the fourth side surface of the holder is, for example, 6 mm.

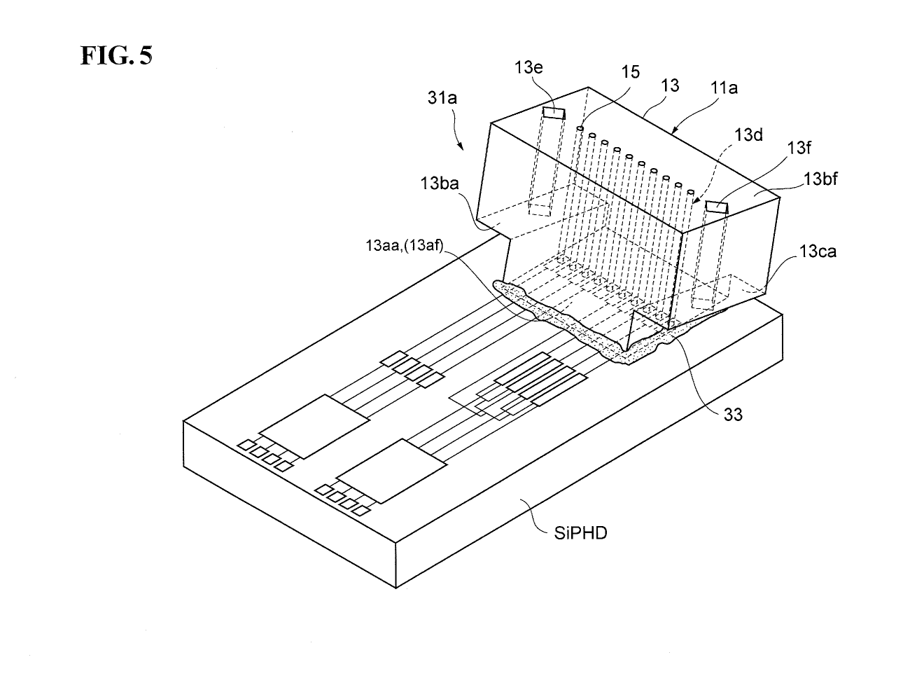

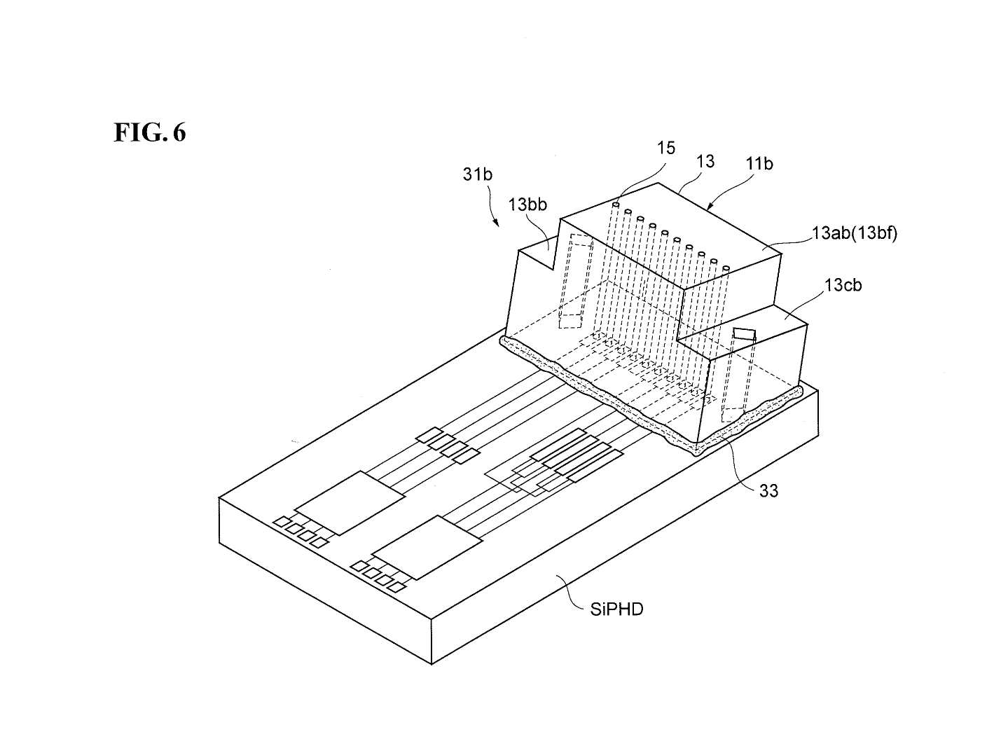

FIG. 5 is a schematic view illustrating an optical communication apparatus according to the present embodiment. An optical communication apparatus 31a includes the fiber stub 11a according to the present embodiment; a planar waveguide device, such as a silicon photonics device SiPHD; and a resin body 33. FIG. 6 is a schematic view illustrating an optical communication apparatus according to the present embodiment. An optical communication apparatus 31b includes the fiber stub 11b according to the present embodiment; an optical integrated device, such as a silicon photonics device SiPHD; and a resin body 33. The fiber stubs 11a and 11b are fixed to a surface of the planar waveguide device by using the resin body 33 for adhesion. The resin body 33 may be, for example, an epoxy-based adhesive or the like that is thermosetting or ultraviolet curable. With the optical communication apparatuses 31a and 31b, the resin body 33 optically connects the planar waveguide device to the optical fibers of the fiber stub, without disturbing the optical connection between the fiber stub and an optical connector which is disposed on the second end face 13ab.

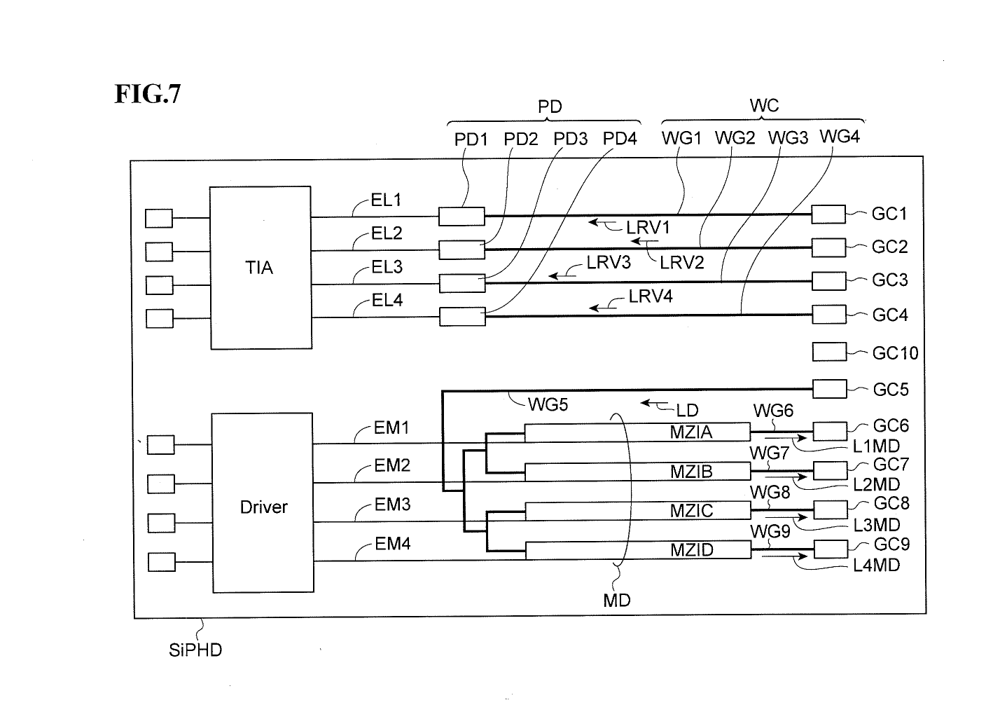

A planar waveguide device generally includes an optical coupler that is to be optically connected to the fiber stub 11a, an optical waveguide that is connected to the optical coupler, and a semiconductor optical device that is connected to the optical waveguide. Referring to FIG. 7, a silicon photonics device SiPHD, which is an example of an planar waveguide device, will be described.

FIG. 7 is a plan view illustrating an example of the planar waveguide device. This example of the planar waveguide device is a silicon photonics device. The silicon photonics device SiPHD includes, as its optical couplers, a plurality of (for example, ten) grating couplers GC1, GC2, GC3, GC4, GC5, GC6, GC7, GCB, CG9, and CG10.

The grating couplers GC1 to CG4 are used for a photodetector. Therefore, the grating couplers GC1 to CG4 receive optical signals from the outside through a fiber stub. Optical signals LRV1, LRV2, LRV3, and LRV4 are provided to a photodetection device PD through optical circuits WC. In the present embodiment, the optical circuits WC include optical waveguides WG1 to WG4. However, this is not a limitation. The grating couplers GC1 to CG4 are optically connected to photodiodes PD1 to PD4 through optical waveguides WG1 to WG4, respectively. The photodiodes PD1 to PD4 are connected to an electrical circuit TIA (for example, a transimpedance amplifier) through conductive wires EL1 to EL4. The electrical circuit TIA performs processing (for example, current-voltage conversion or amplification) of electrical signals (for example, photocurrents) from the photodiodes PD1 to PD4 to generate electrical signals corresponding to the received optical signals.

The grating couplers GC5 to CG9 are used for an optical transmitter. In the present embodiment, a laser beam LD from the grating coupler GC5 is supplied to a plurality of optical modulators MD through an optical waveguide WG5. The optical modulators MD include, for example, Mach-Zehnder modulators MZIA, MZIB, MZIC, and MZID. The Mach-Zehnder modulators MZIA, MZIB, MZIC, and MZID respectively receive electrical signals EM1, EM2, EM3, and EM4 from a driver circuit Driver and generate a plurality of modulated light beams L1MD, L2MD, L3MD, and L4MD in accordance with the electrical signals EM1 to EM4. The modulated light beams L1MD to L4MD respectively propagate through optical waveguides WG6 to WG9 and reaches the grating couplers GC6 to CG9. The grating couplers GC6 to CG9 can provide optical signals to the outside through a fiber stub. Thus, by connecting the grating couplers GC1 to CG9 in the silicon photonics device SiPHD to a fiber stub, the silicon photonics device SiPHD can simultaneously receive light beams from the outside and provide light beams to the outside.

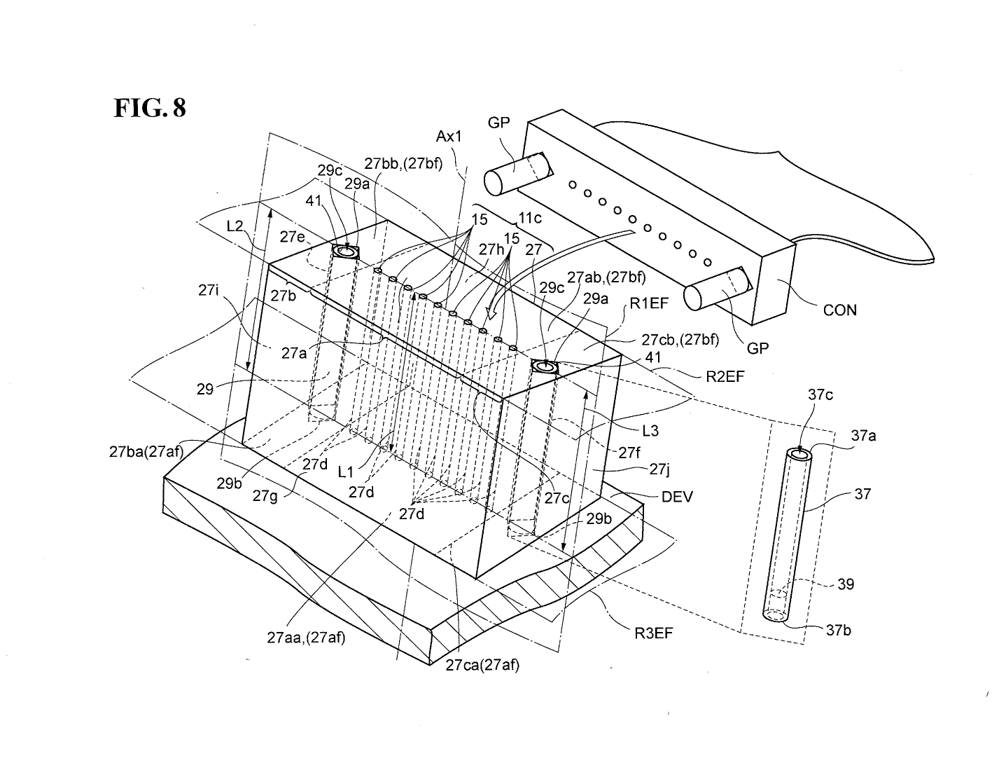

FIG. 8 is a schematic view illustrating a fiber stub according to the present embodiment. A fiber stub 11c includes a holder 27, one or more optical fibers 15, and a guiding portion 29 supported by the holder 27. (In the present embodiment, the number of the optical fibers 15 is ten.)

The holder 27 includes a first portion 27a and a second portion 27b, which are arranged along a first reference plane R1EF. The optical fibers 15 are held by the holder 27. The first portion 27a of the holder 27 includes a first end face 27aa and a second end face 27ab, and the second end face 27ab is located on the opposite side to the first end face 27aa. The first portion 27a includes one or more first holes 27d. (In the present embodiment, the number of the first holes 27d is ten.) The first holes 27d extend from one to the other of the first end face 27aa and the second end face 27ab in a first direction Ax1. The first direction Ax1 extends from the first end face 27aa to the second end face 27ab. The optical fibers 15 extend from the first end face 27aa of the holder 27 through the first holes 27d.

The second portion 27b of the holder 27 includes a third end face 27ba and a fourth end face 27bb, and the fourth end face 27bb is located on the opposite side to the third end face 27ba. The second portion 27b includes a second hole 27e. The second hole 27e extends from one to the other of the third end face 27ba and the fourth end face 27bb in the first direction Ax1. The second hole 27e is formed for the guiding portion 29, which is used for holding a guide pin GP when connecting the fiber stub 11c to an optical connector CON.

The first end face 27aa and the second end face 27ab intersect the first reference plane R1EF, and the third end face 27ba and the fourth end face 27bb interest the first reference plane R1EF.

The guiding portion 29 includes one end 29a, the other end 29b, and a hole 29c. The hole 29c extends from the one end 29a in the first direction Ax1 and terminates at a position between the one end 29a and the other end 29b. The guiding portion 29 is disposed in the second hole 27e and extends from the fourth end face 27bb through the second hole 27e. The guiding portion 29 is embedded in the second hole 27e. An outer surface of the guiding portion 29 is surrounded by an inner surface of the second hole 27e.

The distance between the first end face 27aa and the second end face 27ab at the positions of the first holes 27d of the first portion 27a is a first length L1, and the distance between the third end face 27ba and the fourth end face 27bb at the position of the second hole 27e of the second portion 27b is a second length L2. The first length L1 and the second length L2 are measured in the first direction Ax1, and the second length L2 may be the same as the first length L1.

In the present embodiment, the first holes 27d are arranged along the first reference plane R1EF, and the optical fibers 15 are also arranged along the first reference plane R1EF.

In the fiber stub 11c, the second end face 27ab and the fourth end face 27bb intersect the first reference plane R1EF. To be specific, the second end face 27ab and the fourth end face 27bb extend along a second reference plane R2EF, which intersects both the first reference plane R1EF and the first direction Ax1. The second end face 27ab and the fourth end face 27bb constitute a second facet 27bf.

In the fiber stub 11c, the first end face 27aa and the third end face 27ba intersect the first reference plane R1EF. To be specific, the first end face 27aa and the third end face 27ba extend along a third reference plane R3EF, which intersects both the first reference plane R1EF and the first direction Ax1, and constitute a first facet 27af.

The holder 27 further includes a third portion 27c. In the holder 27, the first portion 27a, the second portion 27b, and the third portion 27c are arranged along the first reference plane R1EF; the first portion 27a is positioned between the second portion 27b and the third portion 27c; and the first portion 27a, the second portion 27b, and the third portion 27c are integrated so as to form the holder 27. The third portion 27c includes a fifth end face 27ca and a sixth end face 27cb, and the sixth end face 27cb is located on the opposite side to the fifth end face 27ca. The third portion 27c includes a third hole 27f extending from the fifth end face 27ca to the sixth end face 27cb in the first direction Ax1. The distance between the fifth end face 27ca and the sixth end face 27cb at the position of the third hole 27f of the third portion 27c is a third length L3, and the third length L3 may be the same as the first length L1. In the present embodiment, the first holes 27d, the second hole 27e, and the third hole 27f are arranged along the first reference plane R1EF.

The first end face 27aa, the third end face 27ba, and the fifth end face 27ca are arranged along the third reference plane R3EF, which intersects the first direction, and constitute the first facet 27af of the fiber stub 11c. In a specific example, the third reference plane R3EF may be inclined with respect to a plane perpendicular to the first direction Ax 1. When the first end face 27aa of the first facet 27af is inclined, the fiber stub 11c can be optically connected to the external component DEV reliably. The inclination angle TH of the first end face 27aa may be, for example, in the range of 6 to 10 degrees.

The fiber stub 11c includes a first side surface 27g, a second side surface 27h, a third side surface 27i, and a fourth side surface 27j. The first side surface 27g, the second side surface 27h, the third side surface 27i, and the fourth side surface 27j extend in the first direction Ax1. The first side surface 27g is positioned on the opposite side to the second side surface 27h, and the third side surface 27i is positioned on the opposite side to the fourth side surface 27j. The first portion 27a, the second portion 27b, and the third portion 27c are arranged in a direction from one to the other of the third side surface 27i and the fourth side surface 27j. Each of the first facet 27af and the second facet 27bf extends from an edge of one of the first side surface 27g and the second side surface 27h to an edge of the other of the first side surface 27g and the second side surface 27h.

With the fiber stub 11c, the optical fibers 15 extend from the first end face 27aa of the first portion 27a of the holder 27 through the first holes 27d. The fiber stub 11c is optically connected to a planar waveguide device DEV through the first end face 27aa of the fiber stub 11c. To connect the fiber stub 11c and an optical connector CON to each other, the fiber stub 11c is aligned with the optical connector CON by inserting a guide pin GP into a hole extending from one end 29a of the guiding portion 29 in the second hole 27e in the first direction Ax1.

A resin body is applied to the first end face 27aa to fix the fiber stub 11c and the planar waveguide device DEV. The applied resin body has fluidity before it is cured, and the resin body spreads not only on the first end face 27aa of the first portion 27a but also toward the second portion 27b. According to the inventor's findings, because the spread resin body flows into a gap between components clue to capillary action, the applied resin body may be absorbed into gaps related to the second hole 27e and/or the guiding portion 29. However, because the hole 29c of the guiding portion 29 terminates at a position between the one end 29a and the other end 29b, it is possible to prevent the resin body, which has spread to the third end face 27ba of the second portion 27b, from reaching the fourth end face 27bb through the hole 29c of the guiding portion 29.

The guiding portion 29 may include a guide pipe 37 and a sealing member 39. The guide pipe 37 includes a first end 37a, a second end 37b, and a via-hole 37c extending from the first end 37a to the second end 37b. The via-hole 37c penetrates through the guide pipe 37. The sealing member 39 is arranged in the via-hole 37c. The sealing member 39 is in contact with an inner surface of the via-hole, and blocks the via-hole 37c of the guide pipe 37. The sealing member 39 may be, for example, a resin or an epoxy-based adhesive or the like that has high viscosity and that is thermosetting or ultraviolet curable. The hole of the guiding portion 29 is terminated by the sealing member 39, which blocks the via-hole 37c.

The sealing member 39 is put in the via-hole 37c between the first end 37a and the second end 37b. The length of the sealing member 39 is shorter than the length of the via-hole 37c. The sealing member 39 is preferably positioned near the second end 37b so that the guide pin GP can be inserted in the via-hole 37c from the first end 37a. To be more specific, the sealing member 39 is formed in the via-hole 37c of the guide pipe 37 by applying a resin including an ultraviolet polymerization initiator to the second end 37b of the guide pipe 37 and curing the resin. The outside diameter of the guide pipe 37 may be, for example, 1.0 mm. The inside diameter of the via-hole 37c of the guide pipe 37 may be, for example, 0.7 mm.

The holder 27 may further include a fixing member 41 that fixes the guiding portion 29 to the second hole 27e. The fixing member 41 blocks a gap between the guiding portion 29 and the second hole 27e. The fixing member 41 may be, for example, a resin member. To be specific, the fixing member 41 may be an epoxy-based adhesive or the like that is thermosetting or ultraviolet curable. The fixing member 41 guarantees that the guiding portion 29 can be securely fixed to the second hole 27e of the holder 27 without forming a gap.

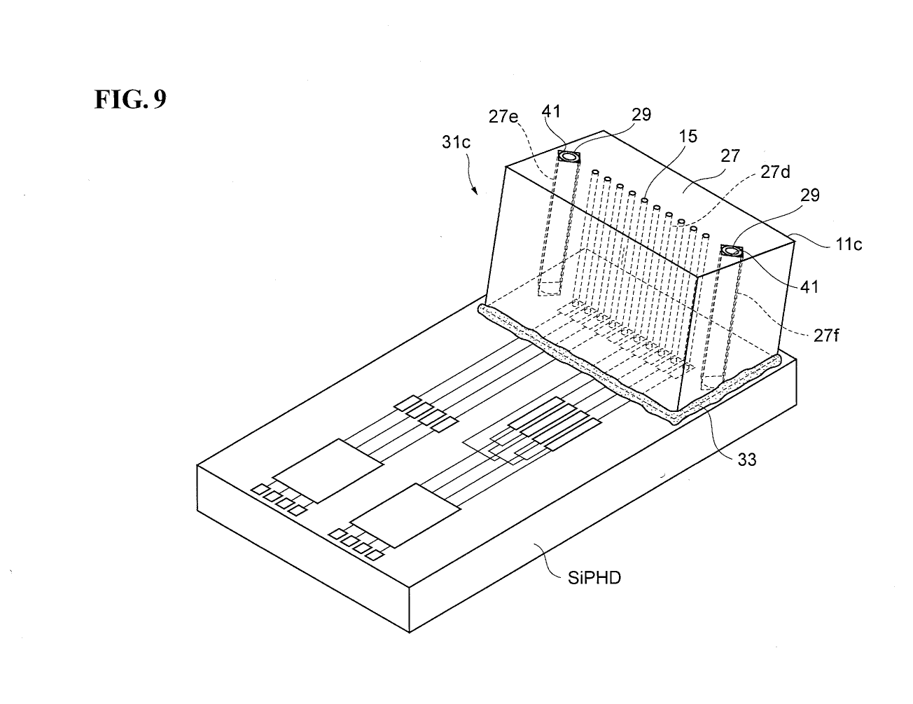

FIG. 9 is a schematic view illustrating an optical communication apparatus according to the present embodiment. An optical communication apparatus 31c includes the fiber stub 11c according to the present embodiment; a planar waveguide device, such as a silicon photonics device SiPHD; and a resin body 33. The fiber stub 11c is fixed to the planar waveguide device by using the resin body 33 for adhesion. With the optical communication apparatus 31c, it is possible to prevent the resin body 33, for optically connecting the planar waveguide device to the optical fibers of the fiber stub, from disturbing the optical connection between the fiber stub and an optical connector. The silicon photonics device SiPHD has been described above with reference to FIG. 7 as an example of an planar waveguide device.

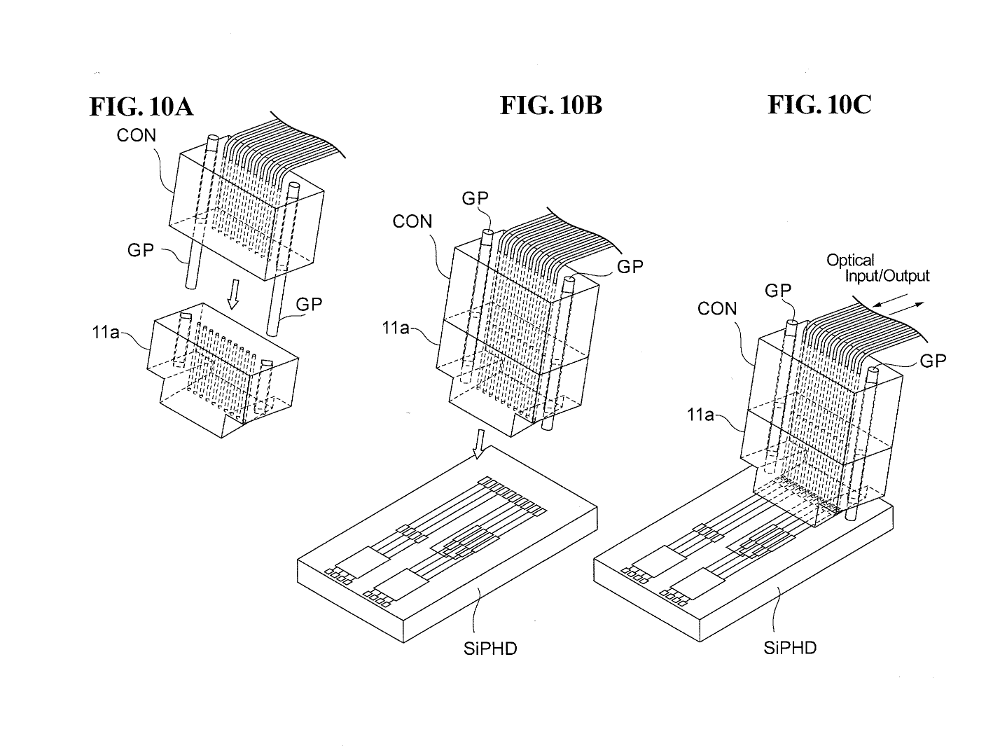

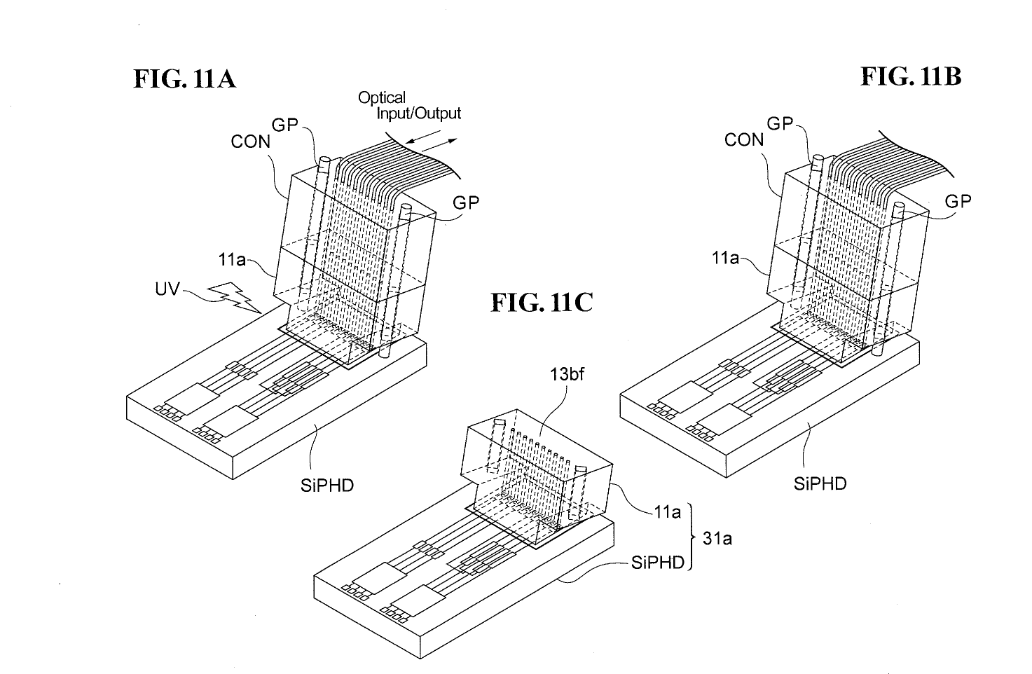

Referring to FIGS. 10A to 11C, a method of making the optical communication apparatus 31a will be described. As illustrated in FIG. 10A, the pigtail-type optical connector CON, the fiber stub 11a, and the silicon photonics device SiPHD are prepared. The pigtail-type optical connector CON may be replaced with a fiber array block having guide holes. The guide pins GP are inserted into the optical connector CON and the second hole 13e and the third hole 13f of the fiber stub 11a, and the optical connector CON is connected to the fiber stub 11a.

As illustrated in FIG. 10B, the fiber stub 11a and the optical connector CON, which have been connected to each other, are preliminarily aligned with the silicon photonics device SiPHD. This alignment is performed, for example, visually.

As illustrated in FIG. 10C, light is input to the optical connector CON, and is coupled to the silicon photonic device SiPHD. The light transmits the optical waveguide in the device SiPHD and is output from the optical couple of the silicon photonic device SiPHD. By monitoring the intensity of light that is output through the silicon photonics device SiPHD, the plurality of optical fibers 15 of the fiber stub 11a are simultaneously and actively aligned with the optical couplers of the silicon photonics device SiPHD.

As illustrated in FIG. 11A, a resin, which includes an ultraviolet polymerization initiator and which is to serve as an adhesive, is applied to a space between the fiber stub 11a and the silicon photonics device SiPHD, and active alignment of the fiber stub 11a with the silicon photonics device SiPHD is performed again. The applied resin does not reach the third end face 13ba and the fifth end face 13ca of the fiber stub 11a along the side surfaces of the guide pins GP while the alignment is being performed. By performing active alignment, the fiber array of the fiber stub 11a is simultaneously aligned. After finishing the alignment, the resin is irradiated with ultraviolet rays to fix the fiber stub 11a to the silicon photonics device SiPHD, thereby making the optical communication apparatus 31a.

As illustrated in FIG. 11B, after fixing the fiber stub 11a to the silicon photonics device SiPHD, the optical connector CON and the guide pins GP are removed from the optical communication apparatus 31a. As illustrated in FIG. 11C, the optical communication apparatus 31a is obtained when the optical connector CON and the guide pins GP have been removed. In the optical communication apparatus 31a, the second facet 13bf of the fiber stub 11a is not contaminated with the adhesive resin that is used to fix the fiber stub 11a and the silicon photonics device SiPHD to each other.

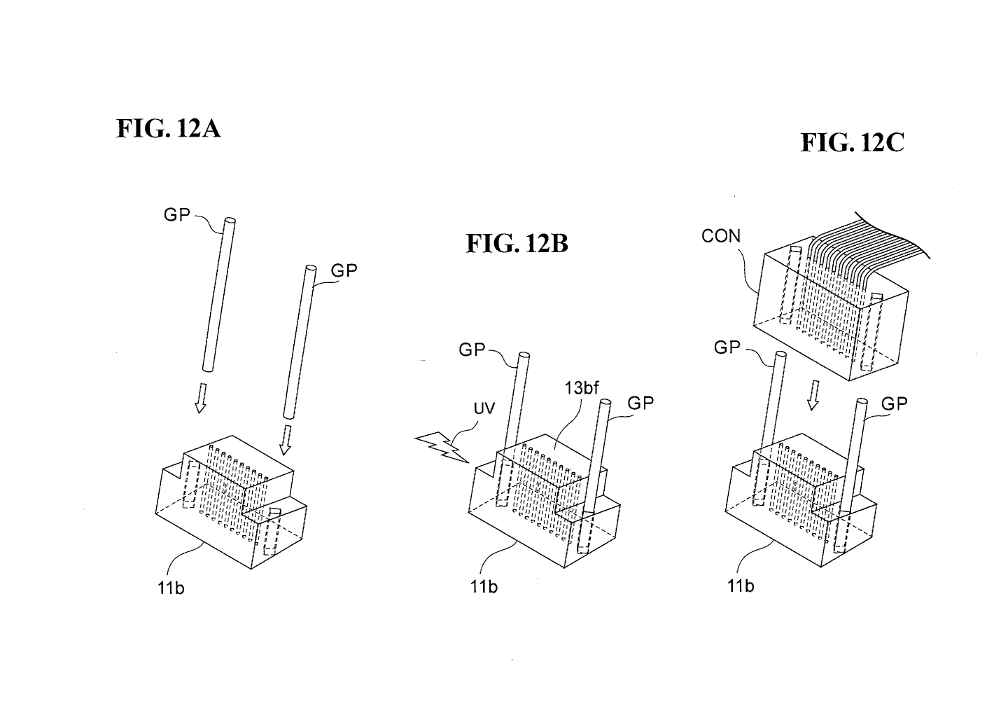

Referring to FIGS. 12A to 14B, a method of making the optical communication apparatus 31b will be described. As illustrated in FIG. 12A, the pigtail-type optical connector CON, the guide pins GP, the fiber stub 11b, and the silicon photonics device SiPHD are prepared. An adhesive including an ultraviolet polymerization initiator is applied to the second hole 13e and the third hole 13f of the fiber stub 11b, and the guide pins GP are inserted into the second hole 13e and the third hole 13f of the fiber stub 11b.

In the present embodiment, as illustrated in FIG. 12B, the applied adhesive is irradiated with ultraviolet rays UV to fix the guide pins GP to the fiber stub 11b. The resin member for fixing the guide pins GP does not reach the second facet 13bf of the fiber stub 11b.

As illustrated in FIG. 12C, the guide pins GP, which have been fixed to the fiber stub 11b, are inserted into the optical connector CON, and the optical connector CON is optically connected to the fiber stub 11b.

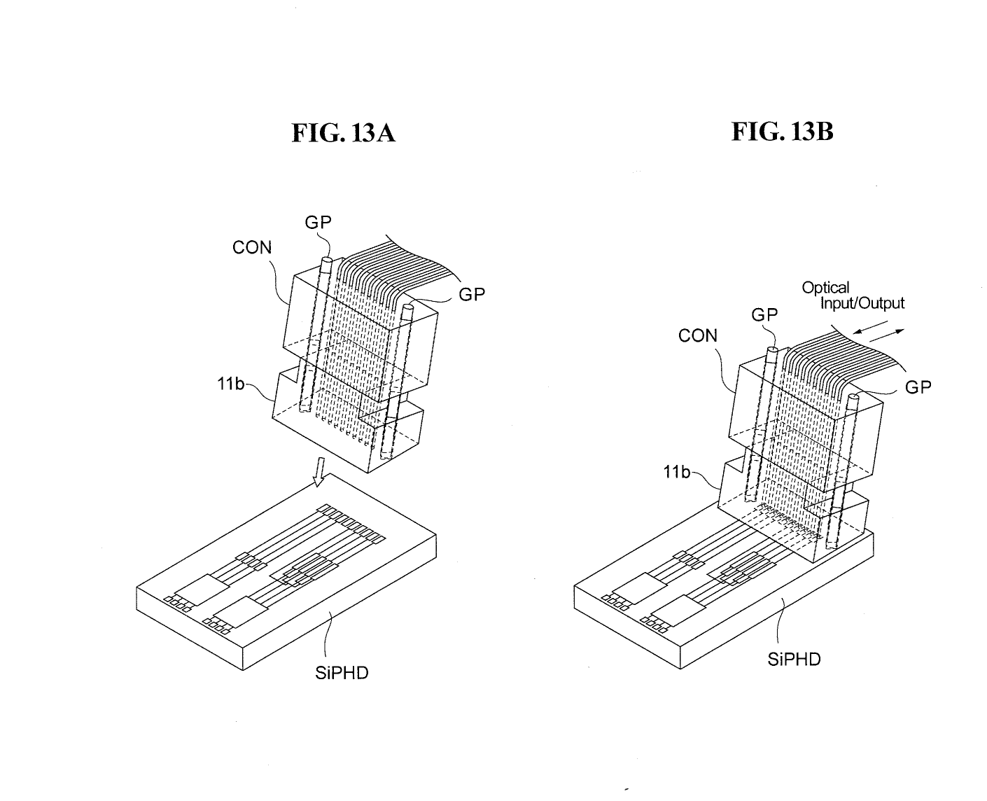

As illustrated in FIG. 13A, the fiber stub 11b and the optical connector CON, which have been connected to each other, are preliminarily aligned with the silicon photonics device SiPHD. This alignment is performed, for example, visually.

As illustrated in FIG. 13B, while inputting light to the optical connector CON and monitoring light that is output through the silicon photonics device SiPHD, the plurality of optical fibers 15 of the fiber stub 11b are actively aligned with the optical couplers of the silicon photonics device SiPHD.

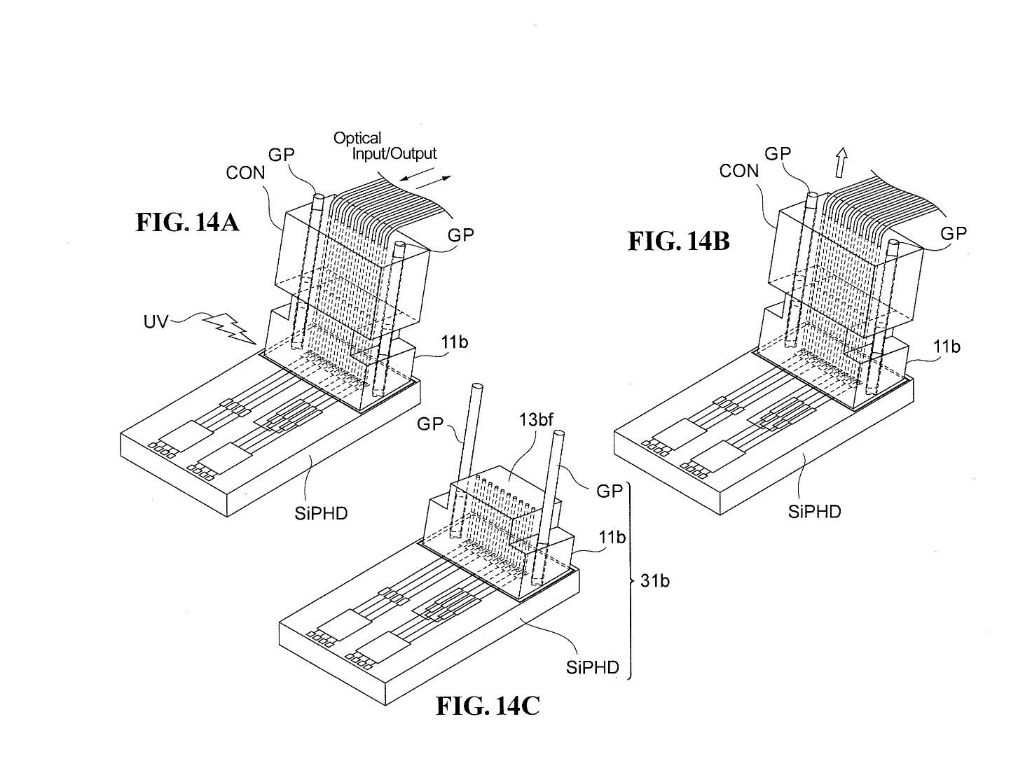

As illustrated in FIG. 14A, a resin, which includes an ultraviolet polymerization initiator and which is to serve as an adhesive, is applied to a space between the fiber stub 11b and the silicon photonics device SiPHD, and active alignment of the fiber stub 11b with the silicon photonics device SiPHD is performed again. The applied resin does not reach the second end face 13ab of the fiber stub 11b along the side surfaces of the guide pins GP while the alignment is being performed. By performing active alignment, the fiber array of the fiber stub 11b is simultaneously aligned. After finishing the alignment, the resin is irradiated with ultraviolet rays to fix the fiber stub 11b to the silicon photonics device SiPHD, thereby making the optical communication apparatus 31b.

As illustrated in FIG. 14B, after fixing the fiber stub 11b to the silicon photonics device SiPHD, the optical connector CON is removed from the optical communication apparatus 31b. As illustrated in FIG. 14C, the optical communication apparatus 31b is obtained when the optical connector CON has been removed. In the optical communication apparatus 31b, the second facet 13bf of the fiber stub 11b is not contaminated with the adhesive resin that is used to fix the fiber stub 11b and the silicon photonics device SiPHD to each other. The optical communication apparatus 31b includes the fiber stub 11b, the silicon photonics device SiPHD, and the guide pins GP.

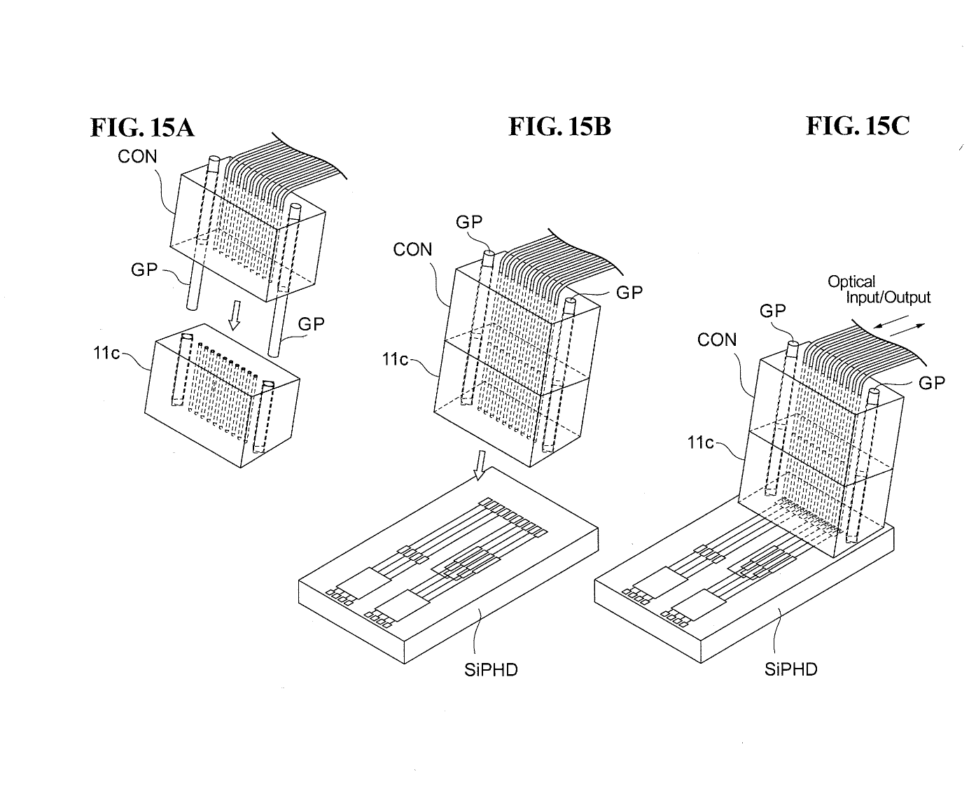

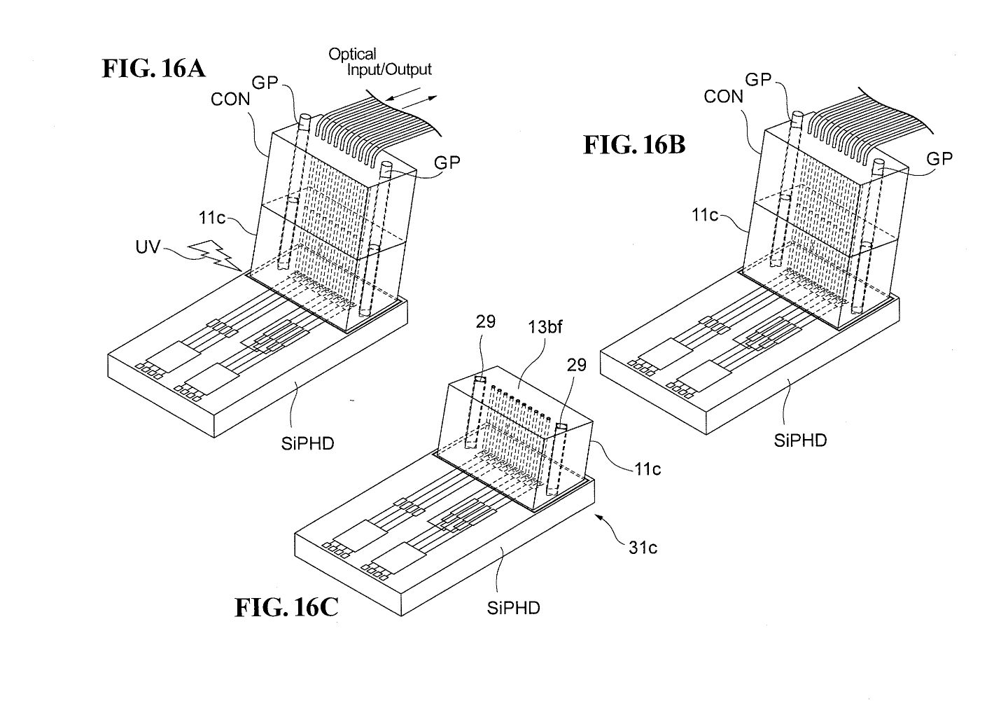

Referring to FIGS. 15A to 16C, a method of making the optical communication apparatus 31c will be described. As illustrated in FIG. 15A, the pigtail-type optical connector CON, the fiber stub 11c, and the silicon photonics device SiPHD are prepared. The pigtail-type optical connector CON may be replaced with a fiber array block having guide holes. The guide pins GP are inserted into the optical connector CON and the guiding portions 29 of the second hole 13e and the third hole 13f of the fiber stub 11c; and the optical connector CON is connected to the fiber stub 11c.

As illustrated in FIG. 15B, the fiber stub 11c and the optical connector CON, which have been connected to each other, are preliminarily aligned with the silicon photonics device SiPHD. This alignment is performed, for example, visually.

As illustrated in FIG. 15C, the fiber stub 11c and the silicon photonics device DEV is actively aligned. While inputting light to the optical connector CON and monitoring light that is output through the silicon photonics device SiPHD, the plurality of optical fibers 15 of the fiber stub 11c are simultaneously aligned with the optical couplers of the silicon photonics device SiPHD.

As illustrated in FIG. 16A, an ultraviolet curable adhesive (resin) is applied so as to be positioned between the fiber stub 11c and the silicon photonics device SiPHD, and active alignment of the fiber stub 11c with the silicon photonics device SiPHD is performed again. The applied resin does not reach the second end face 13ab of the fiber stub 11c along the side surfaces of the guide pins GP while the alignment is being performed. By performing active alignment, the fiber array of the fiber stub 11c is simultaneously aligned. After finishing the alignment, the resin is irradiated with ultraviolet rays to fix the fiber stub 11c to the silicon photonics device SiPHD, thereby making the optical communication apparatus 31c.

As illustrated in FIG. 16B, after fixing the fiber stub 11c to the silicon photonics device SiPHD, the optical connector CON and the guide pins GP are removed from the optical communication apparatus 31c. As illustrated in FIG. 16C, the optical communication apparatus 31c is obtained when the optical connector CON and the guide pins GP have been removed. In the optical communication apparatus 31c, the second facet 13bf of the fiber stub 11c is not contaminated with the adhesive resin that is used to fix the fiber stub 11c and the silicon photonics device SiPHD to each other.

Heretofore, the principles behind the present invention have been illustrated and described by using preferred embodiments. However, it should be clear, to a person having ordinary skill in the art, that the present invention can be modified in design and in details without deviating from the principles. The present invention is not limited to the specific structures disclosed in the embodiments. Accordingly, the scope of the present invention encompasses the claims and any adjustment or modification that is made within the spirit thereof.

What is claimed is:

1. An optical communication apparatus comprising:
a fiber stub including a holder and an optical fiber held by the holder, the holder having a first portion and a second portion that are arranged along a first reference plane;
a planar waveguide device including an optical coupler, an optical waveguide connected to the optical coupler, and a semiconductor optical device connected to the optical waveguide; and
a resin body disposed between the planar waveguide device and the fiber stub,
wherein the first portion of the holder includes a first end face, a second end face on an opposite side to the first end face, and a first hole extending from the first end face to the second end face in a first direction,
the second portion of the holder includes a third end face, a fourth end face on an opposite side to the third end face, and a second hole extending from the third end face to the fourth end face,
the first end face and the third end face intersect the first reference plane,
the optical fiber extends from the first end face of the holder through the first hole, and
the first end face and the second end face are arranged with a first distance that is larger than a second distance between the third end face and the fourth end face.

2. The optical communication apparatus according to claim 1,
wherein the first end face and the third end face are arranged along a third reference plane, and constitute a first facet of the fiber stub,
the second end face extends along a second reference plane, and
the fourth end face is arranged so as to be set back from the second end face in the first direction.

3. The optical communication apparatus according to claim 1,
wherein the second end face and the fourth end face are arranged along a second reference plane, and constitute a second facet of the fiber stub,
the first end face extends along a third reference plane, and
the third end face is arranged so as to be set back from the first end face in the first direction.

4. The optical communication apparatus according to claim 1,
wherein the holder further includes a third portion including a fifth end face, a sixth end face on an opposite side to the fifth end face, and a third hole extending from the fifth end face to the sixth end face,
the first portion is positioned between the second portion and the third portion,
the first hole, the second hole, and the third hole are arranged along the first reference plane, and
the fifth end face and the sixth end face are arranged with a third distance that is smaller than the first distance between the first end face and the second end face.

5. The optical communication apparatus according to claim 1, further comprising:
a guide pin including a portion that is positioned in the second hole.

6. A optical communication apparatus comprising:
a fiber stub including a holder and an optical fiber held by the holder, the holder having a first portion and a second portion that are arranged along a first reference plane;
a planar waveguide device including an optical coupler, an optical waveguide connected to the optical coupler, and a semiconductor optical device connected to the optical waveguide;
a resin body disposed between the planar waveguide device and the fiber stub; and
a guiding portion embedded in the second portion of the holder,
wherein the first portion of the holder includes a first end face, a second end face on an opposite side to the first end face, and a first hole extending from the first end face to the second end face in a first direction,
the second portion of the holder includes a third end face, a fourth end face on an opposite side to the third end face, and a second hole extending from the third end face to the fourth end face,
the first end face and the third end face constitute a first facet of the fiber stub,
the second end face and the fourth end face constitute a second facet of the fiber stub,
the optical fiber extends from the first end face of the holder through the first hole,
the guiding portion extends through the second hole, and
the guiding portion includes one end, the other end, and a hole that extends from the one end in the first direction and that terminates at a position between the one end and the other end.

7. The optical communication apparatus according to claim 6,
wherein the guiding portion includes a guide pipe and a sealing member,
the guide pipe includes a via-hole penetrating through the guide pipe,
the sealing member is arranged in the via-hole, and
the sealing member is in contact with an inner surface of the via-hole.
